(19) United States
(12) Patent Application Publication
(10) Pub. No.: US 2020/0076980 A1
(43) Pub. Date: Mar. 5, 2020

(54) READER AND INK-JET RECORDING DEVICE

(71) Applicant: KONICA MINOLTA, INC., Chiyoda-ku, Tokyo (JP)

(72) Inventors: Yasunori Inaba, Hino-shi, Tokyo (JP); Yoshiyuki Ichihara, Chofu-shi, Tokyo (JP)

(73) Assignee: KONICA MINOLTA, INC., Chiyoda-ku, Tokyo (JP)

(21) Appl. No.: 16/346,995

(22) PCT Filed: Nov. 1, 2017
(86) PCT No.: PCT/JP2017/039528

§ 371 Date: May 2, 2019

(30) Foreign Application Priority Data
Nov. 2, 2016 (JP) 2016-215201

(51) Int. Cl. H04N 1/028; B41J 2/01; H04N 1/193; B41J 29/393

(52) U.S. Cl. CPC H04N 1/02835; B41J 29/393; H04N 1/1936; B41J 2/01

(57) ABSTRACT

Provided are a reader and an ink-jet recording device with which it is possible to maintain the accuracy of reading a document continuously for a longer time. The reader is provided with a detection unit for detecting light from the surface of an object to be read and a housing for shutting the detection unit tight, the housing having a window for allowing the light from the surface of the object to be read to enter the inside via a light permeable member, the window being provided at a position in the housing more separate from the surface of the object to be read than is a nearest surface facing the surface of the object to be read in the shortest distance.

The present U.S. patent application is U.S. National Phase Application of International Application PCT/JP2017/039528 filed on Nov. 1, 2017. This application claims priority of Japanese Patent Application No. 2016-215201 filed on Nov. 2, 2016, the disclosure of which is incorporated herein by reference in its entirety.

### TECHNOLOGICAL FIELD

The present invention relates to a reader and an ink-jet recording device.

### DESCRIPTION OF THE RELATED ART

Conventionally, there has been a reader which reads a document by using a reading sensor, and generates read image data. A reader which reads the whole document by using a line sensor as a reading sensor, and relatively moving the line sensor and the document is used broadly.

Further, there is a technique to perform determination of a normal recording status of a document with an image recorded by an image recording device such as the ink-jet recording device which records an image by discharging an ink onto the recording medium, by reading the document with a reader right after the recording is made. In such a reader, there is a problem that the reading becomes inaccurate due especially to dirt such as the ink mist and dust attaching to and accumulating on the transparent covering member which is the incident route for light into the reading sensor, the mirror, and the lens. With respect to it, conventionally, there has been a technique for not making the dust get inside from an incident opening for light except for at the timing of the reading by providing a shutter in the incident opening (patent document 1). Further in patent document 2, there is disclosed a technique to remove the dirt easily by sticking a sealing member in a pile on the incident opening and peeling the sealing member off every time the dirt occurs.

### PRIOR ART DOCUMENT

### Patent Document

### Patent Document 1: JP 2005-271582

### Patent Document 2: JP 2001-292278

### SUMMARY

### Problems to be Solved by the Invention

However, there is a problem that it is difficult to maintain the reading accuracy of the document without generating the dirt in the incident light route for a long time, especially in a reader which works continuously for a long time.

An object of the present invention is to provide a reader and an ink-jet recording device which can maintain the reading accuracy of the document continuously for a longer time.

### Means for Solving the Problem

In order to achieve the above object, according to an aspect of the invention, a reader includes a detector which detects light from a reading target surface; and a housing which shuts the detector tight, wherein the housing has a window which allows light from the reading target surface to enter an inside of the housing via a light permeable member, and the window is provided at a position in the housing more separate from the reading target surface than a nearest surface facing the reading target surface at a shortest distance.

### BRIEF DESCRIPTION OF THE DRAWINGS

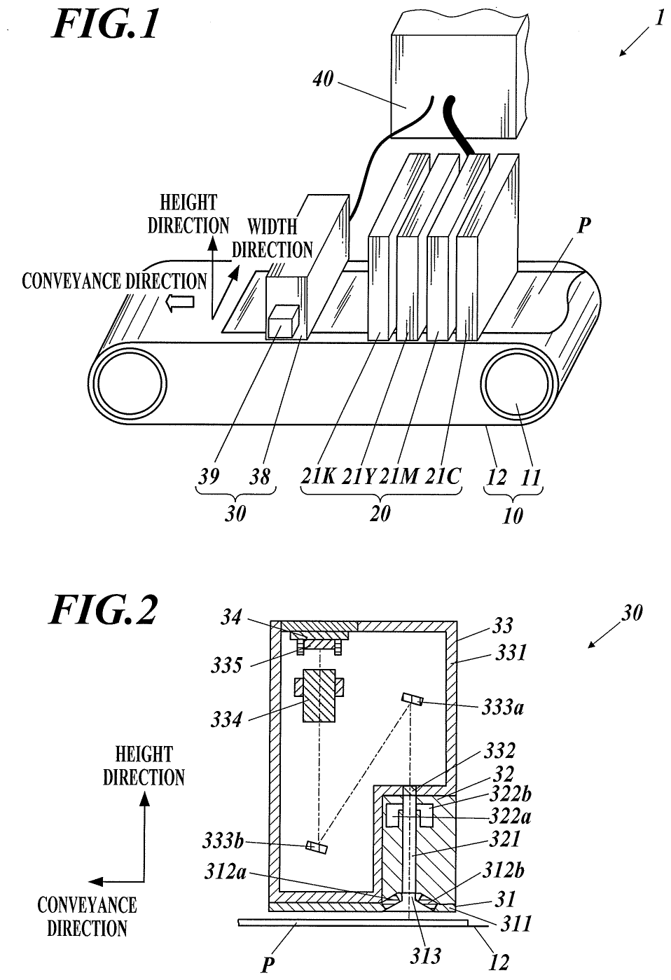

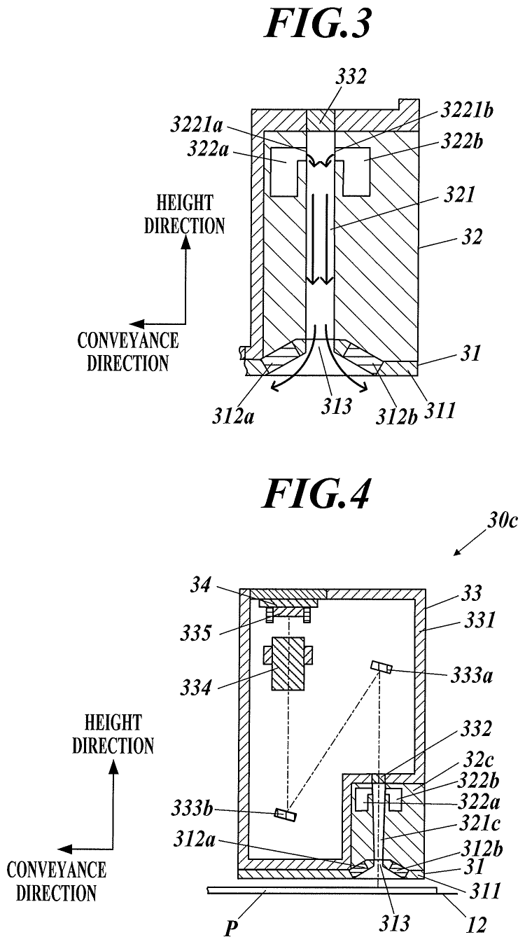

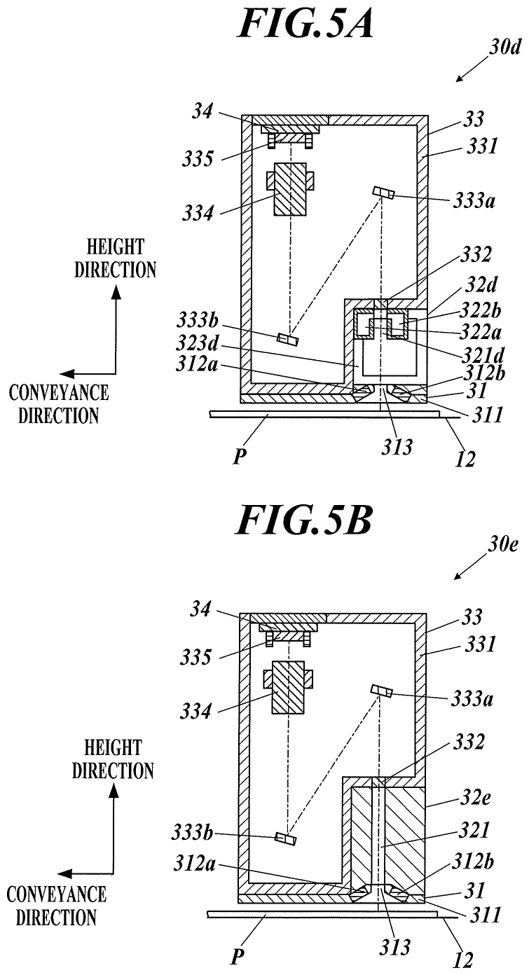

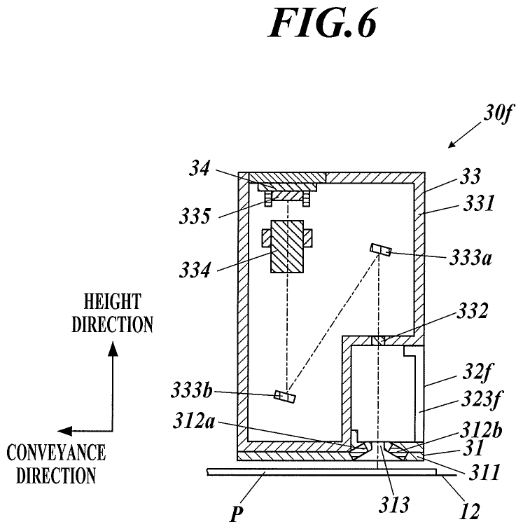

The advantages and features provided by one or more embodiments of the invention will become more fully understood from the detailed description given hereinbelow and the appended drawings which are given by way of illustration only, and thus are not intended as a definition of the limits of the present invention.

[FIG. 1] This is an entire perspective view showing an ink-jet recording device in the embodiment of the present invention.

[FIG. 2] This is a cross-section showing the internal configuration of an imager.

[FIG. 3] This is a cross section describing the illumination unit, and the flow of air in the light guider of the imager.

[FIG. 4] This is a cross section showing modification example 1 of the image reader.

[FIG. 5A] This is a cross section showing modification example 2 of the image reader.

[FIG. 5B] This is a cross section showing modification example 3 of the image reader.

[FIG. 6] This is a cross section showing modification example 4 of the image reader.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present invention will be described on the basis of the drawings.

FIG. 1 is an entire perspective view showing an ink-jet recording device 1 in the embodiment of the present invention.

The ink-jet recording device 1 includes a conveyer 10, an image former 20 (image recorder), an image reader 30 which is an embodiment of a reader of the present invention, a controller 40, and the like.

The conveyer 10 includes a conveyance motor 11, a conveyance belt 12 and the like, and moves the recording medium P mounted on the conveyance surface in the conveyance direction by moving the recording medium P in the predetermined conveyance direction relative to the image former 20 (image recording range) and the image reader 30 (reading target range (reading range)), with the outer periphery surface of the conveyance belt 12 as the conveyance surface, and making the recording medium P pass these ranges.

The image former 20 performs a recording operation which forms an image by making ink land on the upper surface of the recording medium P with an ink discharged from the nozzles. Here, the image former 20 includes four head units 21Y, 21M, 21C, and 21K (hereinbelow also described as head units 21) and discharges respective colors of yellow, magenta, cyan, and black which are each supplied from the ink storage not shown in the figure. The head units 21 are all provided with a nozzle opening made along the recordable width of the recording medium P with a predetermined size in relation to the width direction perpendicular to the conveyance direction in the in-plane which is parallel to the conveyance surface. That is, the width direction component of the arranging range of the nozzle opening is the recordable width of the recording medium P in a predetermined size and it is possible for the ink-jet recording device 1 to discharge the ink on the entire recordable width with the head units 21 fixed. Therefore, each head unit 21 forms a line head and it is possible to form an image in a one-pass method by moving the recording medium P in the conveyance direction. The array pattern of the nozzle opening in each of the head units 21 may be in one dimensional array or in various two-dimensional arrays, or the array direction may have a predetermined angle (that is, the array direction may be leaning) in relation to the width direction.

The image reader 30 is provided in the downstream side of the conveyance direction of the recording medium P in relation to the image former 20, and outputs as image data the image formed by the image former 20 on the recording surface (reading target surface) of the recording medium P. The image reader 30 includes an imager 38, an air blower 39 which is attached on the outside of the imager 38, and the like. The air blower 39 is described later.

The imager 38 includes a line sensor in which the image capture elements are arranged along the recordable width of the head unit 21 so as to be capable of capturing one dimensional image. It is possible to obtain the two-dimensional image on the recording medium P by using a plurality of pieces of one dimensional image data which are obtained by relatively moving the recording medium P with the conveyer 10 in the conveyance direction in relation to the image reader 30, and by performing one dimensional image capturing with the image reader 30 in relation to the width direction using line sensors one after another.

The arrangement to line up of the image capture elements of the line sensor has an arbitrary arrangement interval and an arrangement which can obtain RGB data of the formed image with a necessary resolution. That is, the image capture elements which perform image capturing with each color of RGB each may be in one dimensional array, or the image capture elements which perform image capturing with each color of RGB each may be in conventionally well-known two-dimensional array pattern.

The controller 40 integrally controls the operation of each component in the ink-jet recording device 1.

Next, the internal configuration of the image reader 30 will be described.

FIG. 2 is a cross section showing the internal configuration of an imager 38.

The imager 38 includes an illumination unit 31, a light guider 32, an optical unit 33, an image capture driver 34, and the like.

The illumination unit 31 illuminates the reading target range of the image reader 30. The illumination unit 31 includes a supporting member 311, and two light emitters 312a and 312b (illuminator) which are fixed to the supporting member 311. There is provided an incident opening 313 in the supporting member 311 between the light emitters 312a and 312b.

The light emitters 312a and 312b each include LED (Light Emitting Diode) as a light source, for example. The light emitters 312a and 312b are each provided with an emitting surface (emitting direction) leaning (in diagonal) with respect to the optical axis of light which enters the recording medium P and the incident opening 313 so as to illuminate the reading target range right under the incident opening 313 effectively. Further, the light emitters 312a and 312b may have a configuration which directs the emitting light of the LED to the reading target range more effectively by providing a mirror surface and the like on the side opposite to the emitting surface (the side of the recording medium P) of the LED. It is possible to provide a transparent covering member on the emitting surface to protect the LED light source.

The incident opening 313 is provided facing the recording surface of the recording medium P which is the reading target and is extended in the width direction so that the incident opening 313 matches the entrance of the light guide route 321 of the light guider 32. The incident opening 313 allows light to pass, the light being light from the reading target range of the recording medium P, that is, reflected light in the reading target range by the emitting light from the light emitters 312a and 312b, and allows the light to enter the optical unit 33 via the light guide route 321 so that the reflected light is detected. The incident opening 313 is opened to the outer side of the imager 38.

The supporting member 311 is attachable and detachable with respect to the light guider 32, and the optical unit 33 (that is, the image reader 30), and is fixed with a fixing member such as a screw when in use. The illumination unit 31 is replaced by removing the supporting member 311 from the light guider 32, and the optical unit 33 when deterioration occurs in the light emitting efficiency of the light emitters 312a and 312b and a replacement is necessary.

The light guider 32 includes the light guide route 321 (hole) and two air blowing chambers 322a and 322b.

As described above, the light guide route 321 is provided in a position matching the incident opening 313 of the illumination unit 31, and allows reflected light from the reading target range to pass therethrough and enter the optical unit 33. The length (width) of the light guide route 321 in the width direction is made to extend in the width direction, similarly to the incident opening 313, according to the image capturing range of the line sensor. Further, here, the length (width) of the light guide route 321 in the conveyance direction is formed definitely without depending on the position of the light guide route 321 (the distance from the incident opening 313 and the incident window 332). The emitting opening for light which passed through the light guide route 321 is provided in a position matching the incident opening (window of the housing 331) of the optical unit 33. Here, the light guider 32 is connected to the housing 331 without making a gap (without providing any space) between the emitting opening (one end) for light from the light guide route 321 to the optical unit 33 and the housing 331 (window). It is possible to clean up the window of the housing 331 easily when the ink mist is adhered to the window of the housing 331, by making the connection detachable. Alternatively, the housing 331 of the optical unit 33 and the light guide route 32 may be fixed completely with an adherence member.

A current of air in the light guide route 321 is generated by the air blowing chambers 322a and 322b blowing air into the light guide route 321 via openings, here slits, provided between the light guide route 321 and the air blowing chambers 322a and 322b. Here, the air blower 39 is provided on both sides in the width direction of the air blowing chambers 322a and 322b extending in the width direction, and wind (air) is delivered from the slit to the light guide route 321 by sending wind from the air blower 39 to the air blowing chambers 322a and 322b. The air blower 39 is not particularly limited but may include an ordinary air delivering fan to send the outside air to the air blowing chambers 322a and 322b. The air blower 39 may include a filter to catch the waste and the dust when taking in the outside air.

The optical unit 33 includes the housing 331, the mirrors 333a and 333b, the optical lens section 334, the detector 335 and the like.

By shutting the optical unit 33 tight, the housing 331 prevents the refuse and the ink mist from entering the inside of the optical unit 33 (that is, the mirrors 333a and 333b, the optical lens section 334, and the detector 335), floating and adhering inside the optical unit 33, and obstructing the incident light.

The housing 331 includes a window which causes light from the reading target range passing through the light guide route 321 to enter inside the housing. This window is provided with an incident window member 332 which is made of light (visible light) transmitting member, maintains the housing 331 in a tightly shut condition, and prevents the entrance of the dust and the ink mist to the inner part of the housing 331. The adherence of the dust and the like to the outer surface of the incident window member 332 may be restrained by providing an antifoul layer by performing an antifouling method, and a dustproofing method on the outer surface of the incident window member 332. A well-known transparent member such as a glass plate which allows the visible light to pass is used as the incident window member 332. The incident window member 332 (window) is provided at a position in the housing 331 more distant (separate) from the recording medium P than the surface closest to the recording medium P (nearest surface), that is, the surface connecting with the supporting member 311.

The mirrors 333a and 333b reflect incident light inside the housing 331, and adjust the route and the optical path length of incident light inside the housing 331 to lead incident light to the optical lens section 334. Here, the mirrors 333a and 333b are a plane mirror; however a concave mirror may be used according to the optical path design.

The optical lens section 334 includes one or a plurality of lenses which make convergence and a reduction image of incident light (image) at the position of light receiving elements of the detector 335, and a filter (BPF, LPF) which blocks light with a wavelength which is not a measuring target. The incident window member 332 deviates greatly from the focus since the focus of the optical lens section 334 is made on the surface of the recording medium P and the distance between the recording medium P and the incident window member 332 is taken much larger than the distance between the surface facing the recording medium P in the housing 331 and the recording medium P. Therefore, even if the dust and the ink adhere onto the surface of the incident window member 332, not only the incident light amount which enters a particular image capture element will drop but this disperses to a plurality of image capture elements.

The detector 335 includes the above-mentioned line sensor. As the line sensor, for example, CCD (Charge Coupled Device) sensor and CMOS (Complementary Metal Oxide Semiconductor) sensor are used, and outputs the electric charge and the voltage according to the amount of the incident light for each of the image capture elements. For example, a photo diode and a photocoupler are used as the light receiving elements which output the electric charge for each of the image capture elements according to the amount of the incident light.

The image capture driver 34 causes the imager 38 to perform various operations for reading the image on the recording medium P. The image capture driver 34 generates image capture data from the detected incident light amount data by operating the line sensor of the detector 335, and performs an operation to output data in the memory and the storage of the controller 40. Image captured data may be output in the memory and the storage directly by the DMA (Direct Memory Access) without going through the control by the controller 40. Further, a predetermined calibration operation may be performed when converting incident light amount data to image capture data.

Next, the air blowing operation in the image capturing will be described.

FIG. 3 is a cross section describing the illumination unit 31, and the flow of air in the light guider 32 of the imager 38.

The air blowing chambers 322a and 322b are provided to adjoin the light guide route 321, and deliver wind from the slits 3221a and 3221b to the light guide route 321 with amount of wind according to the air (wind) sent from the air blower 39. The delivered wind flows in the direction moving away from the incident window member 332 (window) toward the incident opening 313 which is open outside, and spouts (outflows) outside from the incident opening 313. The entrance of the dust and the mist into the inner part of the light guide route 321, especially the incident window member 332, is prevented by performing the air blowing operation continuously when the ink-jet recording device 1 is in operation.

An air current generator is configured with the air blower 39, and the air blowing chambers 322a and 322b.

Alternatively, the air blowing operation may be performed from the beginning of an ink discharging operation such as the image forming until the passing of a predetermined time after the operation finishes (is interrupted). In the ink-jet recording device 1 of the present embodiment, the incident window member 332 is arranged to be upper, with respect to the direction of gravity, than the recording surface of the recording medium P, that is, the reading range of the image reader 30. In such way, the dust and the like is difficult to accumulate in the light guide route 321 due to gravity, and the refuse which adheres to the wall surface of the light guide route 321 is blown away easily by the wind since the incident opening 313 (light guide route 321) of the imager 38 is opened downward with respect to the perpendicular (gravity) direction. Therefore, in the imager 38, it is possible to prevent a large dust and the like from fluttering inside the light guide route 321 to obstruct the optical path temporarily when the image forming continuing for a long time is under operation. Further, the adhering of the ink mist that occurs in the image forming is prevented more certainly, which, as a result, avoids a situation in which the ink mist hardens while remaining adhered and becomes difficult to remove by the wind.

Further, the size and the like of the air blowing chambers 322a and 322b, and the slits 3221a and 3221b may be differed appropriately in the width direction so that unevenness does not occur in the distribution in the width direction of the amount and the speed of the wind delivered from the slits 3221a and 3221b, due to the length of the air blowing chambers 322a and 322b or the arrangement of the air blower 39.

Further, as described above, the light emitters 312a and 312b have a leaning wall surface on the outer side of the incident opening 313 so as to widen the width of the light guide route 321 (opening length in the conveyance direction), and thus, the wind which sprouts from the incident opening 313 flows spreading along the wall surface. Therefore, the adherence of the ink mist, the refuse, and the dust to the covering member of the light emitters 312a and 312b is prevented.

Further, the air pressure occurs in the perpendicular direction toward the surface of the recording medium P by the sprout of the air, thereby the force works in the direction to stick the recording medium P onto the conveyance surface to restrain the floating and the positional misalignment of the recording medium P.

As described above, the image reader 30 in the present embodiment includes a detector 335 which detects light from a recording surface of a recording medium P which is a reading target surface; and a housing 331 which shuts the detector 335 tight. The housing 331 has a window which allows light from the recording surface to enter an inside of the housing 331 via an incident window member 332 which is a light permeable member, and

the window is provided at a position in the housing 331 more separate from the recording surface than a nearest surface facing the recording surface at a shortest distance, that is, the surface connecting with the supporting member 311.

In such way, by having a form which arranges the incident window member 332 separate from the focus position of the light entering the detector 335, along with the image reader 30 preventing the entrance of the refuse, the ink mist, and the like into the optical unit 33, and maintaining the appropriate operation of the optical parts and the detector 335, it is possible to restrain the possibility for the detection error to occur due to the drop of the incident light amount to a particular image capture element even if some dirt such as the dust, the ink mist, and the paper powder adhere to the surface of the incident window member 332. Therefore, it is possible to maintain the reading accuracy of the document for a longer time continuously. Further, it is possible to simply decrease the possibility of the adherence of the dirt to the incident window member 332 since the distance from the incident window member 332 and the recording surface is much further than as in usual. Moreover, since the position of the incident window member 332 is separate away from the recording surface but the entire housing 331 is not separate away from the recording surface, the volume of the range including the image reader 30 and the recording surface which is the reading target is not increased according to the increase of the separating amount, and it is possible to restrain the enlargement of the device.

Further, the image reader 30 includes a light guider 32 provided with a light guide route 321 through which light passes from the recording surface at least in one part between the recording surface and the incident window member 332 (window).

In such case, it is possible to restrain the drop in the image quality of the detection image for the noise light and the unnecessary dust entering space between the recording surface and the incident window member 332 which is separate from the recording surface.

Further, the light guider 32 is arranged on the housing 331 without providing any gap between one end of the light guide route 321 and the window. Therefore, it is possible to decrease much more the possibility that the dust and the ink mist adhere to the incident window member 332 since the incident window member 332 is located in the innermost position of the light guide route 321.

Further, the image reader 30 includes the air blower 39 and the air blowing chambers 322a and 322b which generate the air flow in the direction moving away from the incident window member 332 (window) at least in one part between openings on both ends of the light guide route 321. In such way, it is possible to greatly restrain the possibility that the dust and the ink mist which cause dirt come through the light guide route 321 to flow in the direction toward the incident window member 332 and adhere to the incident window member 332. Further, even if the dust and the ink mist flow into the light guide route 321 when the air blower 39 is not in operation, it is possible to eject the dust and the ink mist promptly in the direction of the recording surface by restarting the air blowing before the recording operation and the reading operation begin. Therefore, it is possible to maintain the image quality of the reading image by restraining the bad influence of the dust and the ink mist on the light detection by the detector 335.

Further, the image reader 30 can continue on with the image capturing in a good accuracy by detecting light from the recording surface with sufficient amount of light without depending on the arrangement position of the image reader 30 since there are included the light emitters 312a and 312b which illuminate the recording surface of the recording medium P.

Further, the emitting surfaces of the illumination light by the light emitters 312a and 312b are provided in the positions closer to the recording surface than the incident opening 313 at an end on the recording surface side among both ends of the light guide route 321.

It is possible to irradiate the recording surface so as to obtain enough amount of detecting light from the target which is read without increasing the illuminating amount more than necessary by arranging the light emitters 312a and 312b near the recording surface independently of the arrangement of the housing 331 and the incident window member 332.

Further, the light emitters 312a and 312b may be cooled down by the sprouting air, especially when the air current in the light guide route 321 generated by the air blower 39 sprouts from the incident opening 313.

Further, the light emitters 312a and 312b are fixed on the supporting member 311 and the supporting member 311 is provided to be detachable from the image reader 30 (light guider 32 and optical unit 33).

It is possible to use the image reader 30 more easily in a proper condition for long time since, in a case where the light emitters 312a and 312b deteriorate or damage due to use for a long time, the replacement may be done easily by taking the light emitters 312a and 312b off together with the supporting member 311.

Further, the ink-jet recording device 1 of the present embodiment includes the above-mentioned image reader 30, and the image former 20 which records an image by discharging ink on the surface of the recording medium P which is the reading target.

It is possible to maintain the reading accuracy of the image recorded by the ink-jet recording device 1 stable for a longer time by decreasing the effect of the ink mist caused by the ink discharging from the image former 20, the paper powder caused by the conveyance of the recording medium P, and the like.

Further, the image reader 30 is provided so that the incident window member 332 (window) is arranged upper than the recording surface of the recording medium P with respect to the direction of gravity. In such way, the light guide route 321 is open downward, which enables more decreasing the possibility that the refuse including the paper powder and the dust piles up on the incident window member 332 inside the light guide route 321 due to the influence of gravity and gives bad effect on reading.

Further, the ink-jet recording device 1 includes the conveyer 10 which conveys the recording medium P to make the recording medium P pass the image recording range of the image former 20 and the reading range of the image reader 30, and the image reader 30 is provided in the downstream side of the image former 20 with respect to the conveyance direction of the recording medium P.

In such configuration, the paper powder and the ink mist tend to flow toward the image reader 30 due to the air current caused by moving the conveyance member such as the conveyance belt and the recording medium P. However, by providing the image reader 30 of the present embodiment, it is possible to restrain bad effect given by the paper powder and the ink mist to the reading of the image more effectively, and to maintain the image reading with n appropriate accuracy for a longer time.

Next, the modification example of the image reader will be described.

### Modification Example 1

FIG. 4 is a cross section showing modification example 1 of the image reader.

The image reader 30c in the modification example 1 is formed so that, in the light guider 32c, the light guide route 321c becomes narrower (the opening area becomes smaller) as it comes closer to the incident opening 313. The incident opening 313 is favorable to be formed as narrow as possible in the conveyance direction in the range which does not give effect on the reading target range and the incident light amount from the reading target range. This prevents the inflow of the refuse, the dust, and the ink mist more effectively.

In such way, in the image reader 30c of the modification example 1, the light guide route 321c is formed so that the opening area at the end (incident opening 313) on the side of the recording surface of the recording medium P becomes smaller than the opening area at the end on the side of the incident window member 332 (window).

The image reading accuracy of the image reader 30c is kept appropriately for a longer time since the inflow of the refuse, the dust, and the ink mist from the incident opening 313 is restrained more effectively.

Further, in the image reader 30c of the modification example 1, it is possible to decrease the adherence of the refuse and the ink mist to the incident window member 332 effectively without making the incident window member 332 as distant from the recording surface as the image reader 30 of the above-mentioned embodiment. Thus, even if the position of the incident window member 332 is set closer to the recording medium P than the position of the incident window member 332 in the above-mentioned embodiment, that is, even if the light guide route 321c is shorter, a problem is difficult to occur. Thus, the design can be made easily since the flexibility of the form of the housing 331 and the arrangement of the optical parts inside the housing 331 increases. Further, the size of the housing 331 can be miniaturized more effectively.

Further, the light guide route 321c is formed so that the cross-sectional area becomes smaller as the distance from the incident window member 332 (window) becomes larger at least in one part between both ends. In such a way, by continuously changing the cross-sectional area, it is possible to especially make a stagnant or a whirl difficult to occur in the air current inside the light guide route 321c and generate a smooth current of air. Therefore, even if the refuse and the paper powder enter inside the light guide route 321c, it is possible to prevent the refuse and the paper powder from staying inside.

### Modification Example 2, 3

FIG. 5A is a cross section showing modification example 2 of the image reader. FIG. 5B is a cross section showing modification example 3 of the image reader.

In the image reader 30d of the modification example 2 shown in FIG. 5A, the light guider 32d from the incident opening 313 to the incident window member 332 is not entirely divided with a wall surface. The light guide route 321d is formed only in one part from the position adjoining the incident window member 332, and the other section is opened to the incident opening 313.

The wind delivered from the air blowing chambers 322a and 322b via the slits flows inside the light guide route 321d downward and restrains the entrance of the refuse, the dust, and the ink mist to the inner part of the light guide route 321d to adhere to the surface of the incident window member 332 and the like. In such case, the wind (air) sprouting from the light guide route 321d disperses before the wind reaches the incident opening 313 and only one part of the wind sprouts from the incident opening 313.

The incident opening 313 and the light emitters 312a and 312b, are connected with the air blowing chambers 322a and 322b and the light guide route 321d, with the frame member 323d so as to fix the incident window 313 and the light emitters 312a and 312b to match the position of the wall surface of the air blowing chambers 322a and 322b and the light guide route 321d.

Therefore, in the configuration of the image reader 30d of the modification example 2, the light guide route 321d in the light guider 32d allows light from the recording surface to pass in one part between the recording surface of the recording medium P and the incident window member 332 (window). Even in such configuration, it is possible to restrain the entering of the external light, the refuse, and the ink mist which become the noise with the light guide route 321d, and especially by generating a current of air which flows inside the light guide route 321d in the direction toward the incident opening 313, it is possible to prevent the adherence of the ink mist, the refuse, and the like to the incident window member 332 effectively. Thus, it is possible to maintain the accuracy of the reading image for a longer time.

Further, the image reader 30e shown in the modification example 3 of FIG. 5B is obtained by removing the air blowing chambers 322a and 322b from the image reader 30 in the above-mentioned embodiments. That is, the air flow in the outward direction from the incident window member 332 side to the incident opening 313 does not occur in the light guide route 321 of the image reader 30. On the other hand, since the light guide route 321 is made in a dead-end configuration, the flow of the air toward the inner part of the light guide route 321 is also difficult to occur.

In the configuration of the image reader 30e in the modification example 3, by having the light guide route 321, even though the air blower 39 is not provided, it is possible to make the refuse, the dust, and the ink mist difficult to reach the incident window member 332 comparing with the case where the incident window member 332 is provided directly on the facing surface which faces close to the recording medium P. Further, since the light guide route 321 is made in a dead-end configuration, a flow of the air which intrudes inside the light guide route 321 is difficult to occur. Further, especially when the incident opening 313 is provided in the lower side with respect to the direction of gravity, the precipitation and accumulation of the dust and the like by gravity inside the light guide route 321 is difficult to occur. Further, even if the refuse, the dust, and the ink mist adhere to the incident window member 332, since the surface of the incident window member 332 is separate from the focus of the image capturing by the line sensor, which is the surface of the recording medium P, there is a low possibility that the detection error of the density unevenness and the like occur due to the dirt decreasing the incident light amount to a particular image capture element. Therefore, it is possible to maintain the accuracy of the reading image for a longer time than usual.

### Modification Example 4

FIG. 6 is a cross section showing modification example 4 of the image reader.

In the image reader 30e of the modification example 4 shown in FIG. 6, the light guider 32e is simply a hollow through which incident light from the reading target range, which passes through the incident opening 313, passes to reach the incident window member 332. Here, the light guider 32e includes the supporting member and the frame member 323e to fix the positions of the incident opening 313, and the light emitters 312a and 312b so as to match the position of the incident window member 332.

In the light guider 32e, a flow of the wind which prevents the refuse, the dust, and the ink mist from reaching the incident window member 332, does not occur. However, the ink mist and the paper powder of the recording medium P are difficult to reach the incident window member 332 since the light emitters 312a and 312b, and the like are provided between the recording medium P and the incident window member 332.

In the image reader 30e of the modification example 4, the incident window member 332 (window) is provided in the housing 331 at a position more separate from the recording surface of the supporting member 311 which faces the recording surface in the shortest distance. That is, the light guide route and the air blower are not provided.

In such configuration, since the surface of the incident window member 332 is at a position deviating greatly from the focus point of the optical unit 33, which is set on the surface of the recording medium P, even if the refuse such as the paper powder and the ink mist adheres to the incident window member 332, it is possible to decrease the concern that the detection error of the density unevenness occurs due to the effect given to the detection of a particular image capture element.

### ADVANTAGEOUS EFFECTS OF EMBODIMENTS

By implementing the disclosed embodiments, there is an effect that it is possible to maintain the reading accuracy of the document continuously for a longer time in the reader.

Further, the present invention is not limited to the embodiments above, but various changes could be made.

For example, in the embodiments above, the light guider 32 is provided in a form filling up the concave of the optical unit 33 which is in an L shape, however the optical unit 33 may be in other forms such as in a concaved form (in a U shape). With this change, the arrangement of the optical components and the detector 335 inside the optical unit 33 may be set arbitrarily.

Further, in the above embodiments, the facing surface of the supporting member 311 which faces to the recording surface is provided to be parallel to the conveyance surface of the conveyance belt 12; however, the facing surface is not limited to be parallel. The facing surface may be partially parallel and have a concave/convex form, or the whole surface may be leaning in relation to the conveyance surface (the normal direction does not need to be orthogonal to the conveyance surface). Further, the recording surface of the recording medium P which is conveyed by the conveyance belt 12 does not need to be in a complete plane form, but it is possible for the image reader 30 to target various types of recording medium P which include concave/convex in the readable range according to the f value and the like of the optical unit 33.

Further, in the above embodiments, there are shown an example in which the light guide route 321 penetrates completely through the light guider 32, an example in which the light guide route 321 is provided in one part on the window side, and an example in which the light guide route 321 is not provided. However, the light guide route 321 may be provided in an arbitral part of the light guider 32 along the optical axis toward the detector 335 (that is, between the reading target range (reading target surface) and the incident window member 332).

Further, the light guide route 321c shown in the above modification example 1 is only an example, and the light guide route 321c may be in other forms, for example, in an arbitrary form in which the opening area at the end on the incident opening 313 side in the light guide route 321c is smaller than the opening area at the end on the window side of the housing 331 in the light guide route 321c, such as the form in which only the part closest to the incident opening 313 is narrowed compared to the other parts, and the form in which the light guide route 321c is narrowed gradually toward the incident opening 313.

Further, in the above embodiments, the image reader 30 is described to be in a uniform configuration in the width direction, however, the image reader 30 may be divided or be in a different form as necessary.

Further, the above embodiments has a configuration which pushes out the wind toward the incident opening 313 from the window side in the light guide route 321 by the air blower 39; however, it is possible for the same air flow to occur by providing an absorber in front of the incident opening 313. In such a case, it is favorable to provide a filter on the open sections of the air blowing chambers 322a and 322b, and the slits 3221a and 3221b to prevent the flow of the refuse and the like into the light guide route 321.

Further, it is possible to have a same effect on the image reader which is provided in the upstream side in the conveyance direction of the image former 20, by applying the present invention.

Further, in the above embodiments, the line sensor used in an ink-jet recording device 1 including a line head is given as an example of the image reader 30 to describe, however, the sensor is not limited to the line sensor which can perform image capturing of the entire width direction at once, but the sensor may be a scanning sensor. Further, the wavelength to be read is not limited to the RGB. The sensor may be a sensor of a single color or may be a sensor for other than visible light, for example, an infrared sensor.

Further, the image reader 30 may not include the light emitters 312a and 312b when the external light (external illumination) which lights up the reading target surface is enough, and the arrangement of the light emitters 312a and 312b is not particularly limited to the embodiments shown above. Moreover, the supporting member 311 which the light emitters 312a and 312b are attached to may not be detachable from the image reader 30.

Further, the image reader 30 is not limited to be used in the ink-jet recording device 1 but the image reader 30 may be used in other image recording devices or scanners of electric apparatuses. Further, the vertical arrangement or the like of the image reader 30 may be reversed according to the configuration of other electronic apparatuses and other arrangements of configurations.

The other specific details such as the configurations and structures shown in the above embodiments can be appropriately modified within the scope of the present invention.

Although embodiments of the present invention have been described and illustrated in detail, the disclosed embodiments are made for purposes of illustration and example only and not limitation. The scope of the present invention should be interpreted by terms of the appended claims.

### INDUSTRIAL APPLICABILITY

The present invention is applicable to the reader and the ink-jet recording device.

### EXPLANATION OF REFERENCE NUMERALS

1 ink-jet recording device
10 conveyer
11 conveyance motor
12 conveyance belt
20 image former
21 head unit
21Y, 21M, 21C, 21K head unit
30, 30c, 30d, 30e image reader
31 illumination unit
311 supporting member
312a light emitter
313 incident opening
32, 32c, 32d, 32e light guider
321, 321c, 321d light guide route
322a, 322b air blowing chamber
3221a, 3221b slit
323d, 3223e frame member
33 optical unit
331 housing
332 incident window member
333a, 333b mirror
334 optical lens section
335 detector
34 image capture driver
38 imager
39 air blower
40 controller
P recording medium

1. A reader comprising:
a detector which detects light from a reading target surface; and
a housing which shuts the detector tight, wherein
the housing has a window which allows light from the reading target surface to enter an inside of the housing via a light permeable member, and
the window is provided at a position in the housing more separate from the reading target surface than a nearest surface facing the reading target surface at a shortest distance.

2. The reader according to claim 1, comprising a light guider that includes a hole through which the light passes at least in a part between the reading target surface and the window.

3. The reader according to claim 2, wherein the light guider is arranged on the housing without providing a gap between one end of the hole and the window.

4. The reader according to claim 2, comprising an air current generator which generates an air current in a direction of moving away from the window at least in a part between openings at both ends of the hole.

5. The reader according to claim 2, wherein the hole is formed so that an opening area at an end on a reading target surface side is smaller than an opening area at an end on a window side.

6. The reader according to claim 5, wherein the hole is formed so that a cross-sectional area becomes smaller as a distance from the window becomes larger at least in a part between both ends.

7. The reader according to claim 1, comprising an illuminator which illuminates the reading target surface.

8. The reader according to claim 2, comprising an illuminator which illuminates the reading target surface, wherein an emitting surface of illumination light by the illuminator is provided at a position closer to the reading target surface than an end on a reading target surface side among both ends of the hole.

9. The reader according to claim 7, wherein
the illuminator is fixed to a supporting member, and
the supporting member is detachably provided to the reader.

10. An ink-jet recording device, comprising:
the reader according to claim 1; and
an image recorder which records an image by discharging ink to a surface of a recording medium that is a reading target.

11. The ink-jet recording device according to claim 10, wherein the reader is provided so that the window is arranged upper than the reading target surface with respect to a gravity direction.

12. The ink-jet recording device according to claim 10, comprising a conveyer which conveys the recording medium to make the recording medium pass an image recording range of the image recorder and a reading range of the reader, wherein the reader is provided downstream of the image recorder in a conveyance direction of the recording medium.
